(19) United States
(12) Patent Application Publication
(10) Pub. No.: US 2020/0110603 A1
(43) Pub. Date: Apr. 9, 2020

(54) EXPANDABLE MOBILE PLATFORM

(71) Applicant: TECO ELECTRIC & MACHINERY CO., LTD., New Taipei City (TW)

(72) Inventors: Chia-Jen LIN, New Taipei City (TW); Cheng-Hao LEE, New Taipei City (TW); Shih-Chang CHEU, New Taipei City (TW)

(21) Appl. No.: 16/173,566

(22) Filed: Oct. 29, 2018

(30) Foreign Application Priority Data
Oct. 3, 2018 (TW) 107134970

(51) Int. Cl. G06F 9/22; G05D 1/02

(52) U.S. Cl. CPC G06F 9/226; G05D 1/0274; G05D 1/0278

(57) ABSTRACT

An expandable mobile platform is utilized for receiving and executing a plurality of instructions, each instruction has a target position and a target action. The expandable mobile platform includes a mobile platform and an expandable working mechanism. The mobile platform includes a storage module, a positioning module, an instruction ordering module, and a control module. The storage module is utilized for storing a map data and the instructions. The positioning module is utilized for determining a current position of the mobile platform. The instruction ordering module is utilized for analyzing the current position and a plurality of target positions of the instructions, and aligning the target positions as an instruction serial. The control module is utilized for generating moving control signals to control the mobile platform moving to the target positions and action control signals to control the expandable working mechanism executing the target actions according to the instruction serial.

### BACKGROUND OF INVENTION

### 1. Field of the Invention

The present invention is related to a mobile platform, and more particularly is related to an expandable mobile platform.

### 2. Description of the Prior Art

Attending with the development of artificial intelligence (AI) technologies, more and more mobile robots or service robots have emerged in the market and gradually applied to various businesses, such as the food-delivering robots used in the restaurants, the service robots used in the bank, or the recent luggage-delivering robots used in the airports, and etc.

In addition to the humanoid robot, the automated guided vehicle (AGV), also known as automated mobile vehicle, can also be regarded as within the generalized definition of AI.

However, the conventional technology cannot let the robot thinks independently without a research team behind or an instruction in advance to instruct the robot doing the corresponding action. Generally, the robot in present can only do the action under the instruction inputted by the user, and the user needs to wait for the completion of a previous instruction before inputting a following instruction to instruct the robot doing the corresponding action. The aforementioned process would cause inconvenience to the users and reduce the usage efficiency of robots.

### SUMMARY OF THE INVENTION

In views of the conventional technology, which has the problems that the user needs to input the instruction to ask the robot doing the corresponding action and needs to wait for the completion of a previous instruction before inputting the following instruction. It is a main object of the present invention to provide an expandable mobile platform, which is capable of receiving and executing several instructions as a bundle.

In order to resolve the aforementioned problem, an expandable mobile platform is provided. The expandable mobile platform is adapted for receiving and executing a plurality of instructions, each of the instructions has a target position and a target action such that a plurality of the target positions and a plurality of the target actions are defined, and the expandable mobile platform comprises a mobile platform and an expandable working mechanism.

The mobile platform comprises a storage module, a positioning module, an instruction ordering module, and a control module. The storage module stores a map data and the instructions. The positioning module is communicated with the storage module and is utilized for determining a current position of the mobile platform by using the map data. The instruction ordering module is communicated with the storage module and the positioning module. The instruction ordering module is utilized for analyzing the target positions, defining the target position closest to the current position as a first target position which is ranked first in a position order table, defining the target position closest to the first target position as a second target position which is ranked second in the position order table, and aligning the instructions as an instruction serial based on ranking of the corresponding target positions in the order position table after all the target positions are ranked in the position order table. The control module is communicated with the instruction ordering module, receives the instruction serial, generates a plurality of moving control signals corresponding to the plurality of target positions and a plurality of action control signals corresponding to the target actions accordingly, and controls the mobile platform moving to the target positions according to the ranking in the position order table.

The expandable working mechanism is disposed on the mobile platform for receiving the action control signals corresponding to the target positions and the target actions to execute the target actions as the mobile platform is moved to the target positions.

In accordance with an embodiment of the expandable mobile platform of the present invention, the mobile platform further comprises a missing determination module. When missing determination module determines that the expandable mobile platform is executing a missing instruction among the instructions and is under a missing status, the missing determination module is utilized for generating a missing signal and transmitting the missing signal to the positioning module, the positioning module is utilized for determining a missing position of the expandable mobile platform, the instruction ordering module is utilized for eliminating the missing instruction, analyzing the target positions of the remaining instructions, defining the target position closest to the missing position as a first modified target position which is ranked first in a modified position order table, defining the remaining target position closest to the first modified target position as a second modified target position which is ranked second in the modified position order table, and aligning the remaining instructions as a modified instruction serial based on ranking of the corresponding target positions in the order position table after all the remaining target positions are ranked in the modified position order table, and the control module receives the modified instruction serial, generates a plurality of modified moving control signals corresponding to the remaining target positions and a plurality of modified action control signals corresponding to the target actions of the remaining instructions, and controls the mobile platform moving to the remaining target positions and controls the expandable working mechanism executing the remaining target actions corresponding to the remaining target positions.

In accordance with an embodiment of the expandable mobile platform of the present invention, the missing determination module comprises a track determination unit, an action determination unit, and a missing signal transmitting unit. The track determination unit is utilized for generating a track missing signal when determining that the mobile platform cannot move to one of the target positions and is under a track missing status of the missing status. The action determination unit is utilized for generating an action missing signal when determining that the expandable mechanism cannot execute one of the target actions and is under an action missing status of the missing status. The missing signal transmitting unit is communicated with the track determination unit and the action determination unit for generating the missing signal when receiving at least one of the track missing signal and the action missing signal.

In accordance with an embodiment of the expandable mobile platform of the present invention, the expandable working mechanism comprises an action feedback unit for generating an action completion feedback signal when the expandable working mechanism completes anyone of the target actions.

In accordance with an embodiment of the expandable mobile platform of the present invention, the storage module is a memory, a database, or a storage chip.

In accordance with an embodiment of the expandable mobile platform of the present invention, the positioning module comprises at least one of a GPS positioning unit, a Bluetooth positioning unit, and a Wifi positioning unit.

In accordance with an embodiment of the expandable mobile platform of the present invention, the instruction ordering module is a central processing unit (CPU).

In accordance with an embodiment of the expandable mobile platform of the present invention, the control module is a microcontroller unit (MCU).

In accordance with an embodiment of the expandable mobile platform of the present invention, the control module comprises a moving control unit and an action control unit. The moving control unit is utilized for generating the moving control signals. The action control unit is utilized for generating the action control signals.

As mentioned, by using the storage module, the positioning module, the instruction ordering module, and the control module to store all the instructions, analyzes the current position and the target positions of all the instructions so as to align the target positions as an instruction serial for controlling the mobile platform and expandable working mechanism moving to the target position and executing the target actions.

### BRIEF DESCRIPTION OF THE DRAWINGS

The present invention will now be specified with reference to its preferred embodiment illustrated in the drawings, in which:

FIG. 1 is a block diagram of an expandable mobile platform provided in accordance with a preferred embodiment of the present invention;

FIG. 2 is a schematic view showing the storage of the instructions in the storage module of the expandable mobile platform provided in accordance with a preferred embodiment of the present invention;

FIG. 3 is a schematic view showing the map data in the storage module of the expandable mobile platform provided in accordance with a preferred embodiment of the present invention;

FIG. 4 is a schematic view showing ordering of instructions by using the instruction ordering module of the expandable mobile platform provided in accordance with a preferred embodiment of the present invention;

FIG. 5 is a schematic view showing the motion of the expandable mobile platform provided in accordance with a preferred embodiment of the present invention;

FIG. 6 and FIG. 7 are schematic views showing the expandable mobile platform under the missing status provided in accordance with a preferred embodiment of the present invention;

FIG. 8 is a schematic view showing reordering of instructions by using the instruction ordering module of the expandable mobile platform provided in accordance with a preferred embodiment of the present invention; and

FIG. 9 is a schematic view showing the modified motion of the expandable mobile platform provided in accordance with a preferred embodiment of the present invention.

### DESCRIPTION OF THE PREFERRED EMBODIMENT

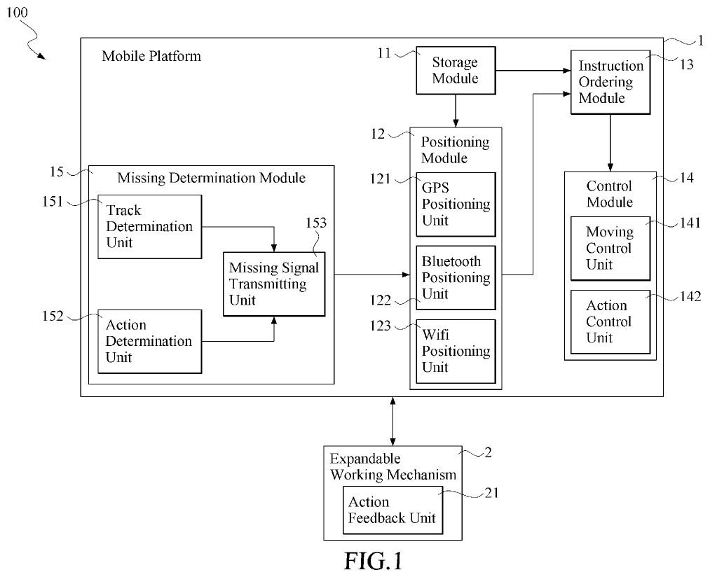

Please refer to FIG. 1, wherein FIG. 1 is a block diagram of an expandable mobile platform provided in accordance with a preferred embodiment of the present invention. As shown, the expandable mobile platform 100 comprises a mobile platform 1 and an expandable working mechanism 2 disposed on the mobile platform 1.

The mobile platform 1 comprises a storage module 11, a positioning module 12, an instruction ordering module 13, and a control module 14. In the present preferred embodiment, the mobile platform 1 further comprises a missing determination module 15.

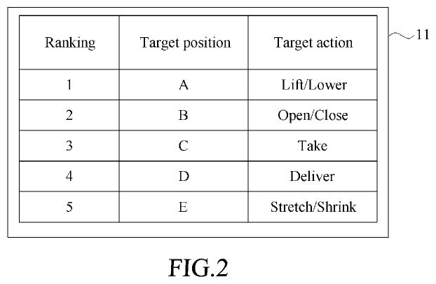

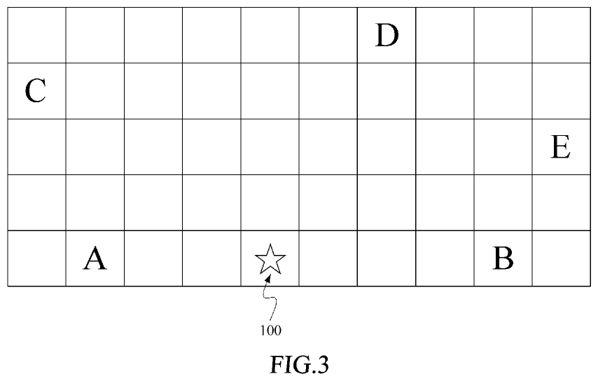

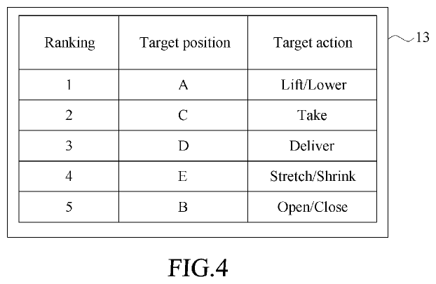

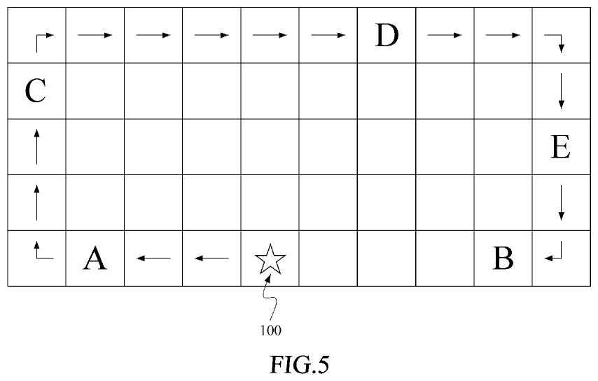

Please refer to FIGS. 1 to 5, wherein FIG. 2 is a schematic view showing the storage of the instructions in the storage module of the expandable mobile platform provided in accordance with a preferred embodiment of the present invention, FIG. 3 is a schematic view showing the map data in the storage module of the expandable mobile platform provided in accordance with a preferred embodiment of the present invention, FIG. 4 is a schematic view showing ordering of instructions by using the instruction ordering module of the expandable mobile platform provided in accordance with a preferred embodiment of the present invention, and FIG. 5 is a schematic view showing the motion of the expandable mobile platform provided in accordance with a preferred embodiment of the present invention. The expandable mobile platform 100 is utilized for receiving and executing a plurality of instructions. Each instruction has a target position and a target action, such that the plurality of instructions would define a plurality of the target positions and a plurality of the target actions.

As shown in FIG. 2, the storage module 11 stores the received plural instructions. Each instruction has a target position, a target action, and also an instruction ranking number. In the present embodiment, the instruction ranking number indicates the receiving order of the instructions, which is irrelevant to the executing order of the expandable mobile platform 100. In addition, the storage module 11 also stores a map data of a working environment in which the expandable mobile platform is situated as shown in FIG. 3. The storage module 11 can be a memory, a storage chip or a database.

The positioning module 12 is communicated with the storage module 11 and is utilized for determining a current position of the mobile platform 1 based on the map data, i.e. the position labelled star in FIG. 3. The positioning module 12 includes a GPS positioning unit 121, a Bluetooth positioning unit 122, and a Wifi positioning unit 123. When the expandable mobile platform 100 is situated outdoor, the GPS positioning 121 can be used for outdoor positioning, whereas, when the expandable platform 100 is situated indoor, the Bluetooth positioning unit 122 and the Wifi positioning unit 123 can be used for indoor positioning.

The instruction ordering module 13 is communicated with the storage module 11 and the positioning module 12. The instruction ordering module 13 analyzes all the target positions of all the instructions in FIG. 2 and defines the target position among all the target position closet to the current position as a first target position, i.e. the target position A. The first target position is ranked first in a position order table. Thereafter, the remaining target positions are analyzed to define the target position closet to the first target position as a second target position, i.e. the target position C. Similarly, the second target position is ranked second in the position order table. The instruction ordering module 13 would analyze all the target positions. In the present embodiment, the third target position is the target position D, the fourth target position is the target position E, and the target position B is the fifth target position. Finally, the instruction ordering module 13 would align the instructions as an instruction serial based on the ranking thereof in the position ranking table.

The control module 14 is communicated with the instruction ordering module 13 for receiving the instruction serial and generating a plurality of moving control signals corresponding to the target positions A, B, C, D, and E, and a plurality of action control signals corresponding to the target actions accordingly, so as to control the mobile platform 1 moving to the target positions A, C, D, E, and B in order based on the instruction serial as shown in FIG. 5. The control module 14 includes a moving control unit 141 and an action control unit 142. The moving control unit 141 is utilized for generating the aforementioned moving control signals. The action control unit 142 is utilized for generating the aforementioned action control signals.

The expandable working mechanism 2 is utilized for receiving the action control signals corresponding to the target positions A, C, D, E, and B and the target actions when the mobile platform 1 is moving to the target positions A, C, D, E, and B, respectively. As shown in FIG. 4 and FIG. 5, the corresponding target action for the expandable working mechanism 2 when moving to the target position A is lifting/lowering, the corresponding target action when moving to the target position D is taking, and so on. The expandable working mechanism 2 can be an elevating platform, a rotating platform, a mechanical arm, or an openable container. The expandable working mechanism 2 includes an action feedback unit 21, which is utilized for generating an action completion feedback signal when the execution of anyone of the target actions has completed.

The expandable mobile platform 100 generates the instruction serial by storing all the instructions and analyzing the current position and the target positions of the instructions. Thus, the expandable mobile platform 100 can follow a most efficient route to reach all the target positions and use the expandable working mechanism 2 to complete all the target actions. Thus, the problem of the conventional art derived from the limitation that the robot cannot accept another instruction until a previous instruction has been completed can be resolved and the moving efficiency of the expandable mobile platform 100 can be effectively enhanced.

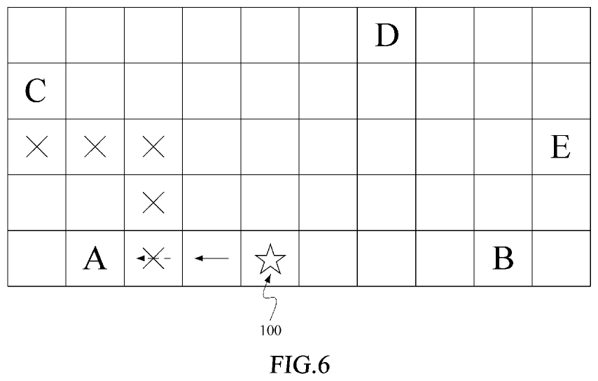

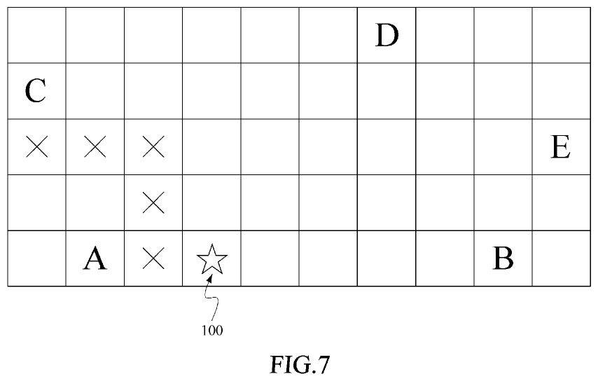

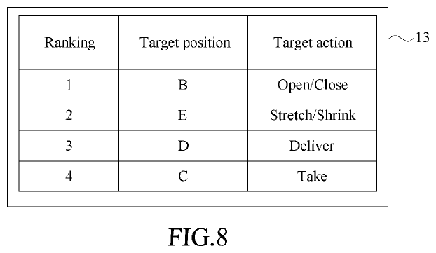

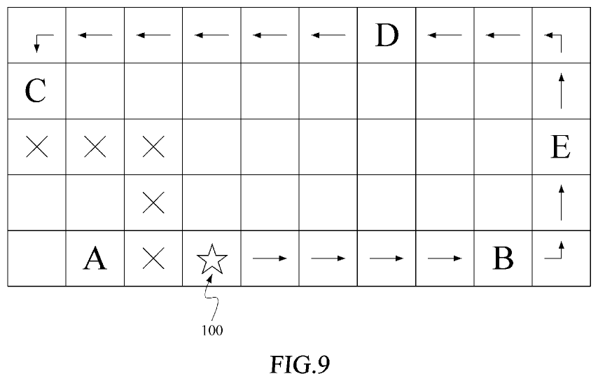

Afterward, please refer to FIG. 1, FIG. 2, and FIGS. 6 to 9, wherein FIG. 6 and FIG. 7 are schematic views showing the expandable mobile platform under the missing status provided in accordance with a preferred embodiment of the present invention, FIG. 8 is a schematic view showing reordering of instructions by using the instruction ordering module of the expandable mobile platform provided in accordance with a preferred embodiment of the present invention, and FIG. 9 is a schematic view showing the modified motion of the expandable mobile platform provided in accordance with a preferred embodiment of the present invention.

As shown in FIG. 6, which shows another application of the present invention, the expandable mobile platform 100 located at a current position, which is labelled star, wants to move to the first target position, i.e. the target position A. However, during the movement, an obstacle X exists in the moving path. Thus, the expandable mobile platform 100 cannot move to the target position A and would be turned into a missing status. The missing status indicates the condition that the expandable mobile platform 100 cannot reach the target position. However, the present invention is not restricted thereto. The missing status can also indicate the condition that the expandable mobile platform 100 cannot executing the target action after reaching the target position.

The missing determination module 15 is communicated with the positioning module 12 for generating a missing signal after determining that the expandable mobile platform 100 is under the missing status. The positioning module 12 would determine the current position of the expandable mobile platform 100 again after receiving the missing signal and define the position as a missing position, i.e. the position labelled star in FIG. 7.

In the present embodiment, the missing module 15 includes a track determination unit 151, an action determination unit 152, and a missing signal transmitting unit 153. The track determination unit 151 is utilized for generating a track missing signal when determining that the mobile platform 1 cannot move to anyone of the target positions and is under a track missing status of the missing status. The action determination unit 152 is utilized for generating an action missing signal when determining that the expandable working mechanism 2 cannot execute anyone of the target actions and is under an action missing status of the missing status. The missing signal transmitting unit 153 is communicated with the track determination unit 151 and the action determination unit 152, for generating the aforementioned missing signal when receiving at least one of the track missing signal and the action missing signal.

In addition, the action determination unit 152 may determine that the expandable working mechanism 2 of the expandable mobile platform 100 is under the action missing status as the action determination unit 152 does not receive the actin completion feedback signal generated by the action feedback unit 21 of the expandable working mechanism 2 after the mobile platform 1 has been moved to the target position.

The instruction ordering module 13 would eliminate the instruction which cause the missing status and the target position thereof, i.e. the target position A in the present embodiment. The instruction ordering module 13 would analyze the missing position and the remaining target positions B, C, D, and E again, and define the target position among the remaining target positions B, C, D, and E closest to the missing position as a first modified target position, i.e. the target position B. The first modified target position is ranked first in a modified position order table. Thereafter, the instruction ordering module 13 would analyze the remaining target positions C, D, and E again and define the target position closest to the first modified target position as a second modified target position, i.e. the target position E. Similarly, the second modified target position is ranked second in the modified position order table. By using the aforementioned process, the target position D is defined as the third modified target position, and the target position C is defined as the fourth modified target position. Finally, the instruction ordering module 13 aligns the instructions as a modified instruction serial based the corresponding ranking in the modified position order table as shown in FIG. 8.

The control module 14 would generate the modified moving control signals corresponding to the target positions B, C, D, and E, and the modified action control signal corresponding to the target actions so as to control the mobile platform 1 moving from the missing position to the target positions B, E, D, and C in order to have the expandable mobile platform 100 escape the missing status as shown in FIG. 9. The expandable mobile platform 100 would move to the target positions B, E, D, and C in order and execute the corresponding target actions.

Moreover, in accordance with the other embodiments of the present invention, the expandable mobile platform further comprises a display module for showing the diagrams of FIG. 2, FIG. 4, and FIG. 8 to show the moving sequence of the expandable mobile platform and the target actions corresponding to the target positions of the moving sequence to an user. The display module can be a display screen.

In conclusion, the expandable mobile platform provided in the present invention features the technologies of using the storage module to store all the instructions, using the positioning module and the instruction ordering module to align all the instructions as an instruction serial, and finally using the control module to control the mobile platform moving to the target positions according to the instruction serial in order and to control the expandable working mechanism doing the corresponding target actions.

In comparison to the conventional technology, the expandable mobile platform is capable to receive a following instruction without the need to wait for the completion of the instruction action of a previous instruction such that the usage of the expandable mobile platform can be more convenient. In addition, the feature of analyzing all the instructions and align the instructions as an instruction serial is helpful for moving the expandable mobile platform more efficiency. Moreover, the expandable mobile platform further has the missing module, which is helpful for assisting the expandable mobile platform escaping the missing status and modifying the instruction serial to have the expandable mobile platform moving to the remaining target positions and executing the corresponding target actions efficiently.

While the present invention has been particularly shown and described with reference to a preferred embodiment, it will be understood by those skilled in the art that various changes in form and detail may be without departing from the spirit and scope of the present invention.

What is claimed is:

1. An expandable mobile platform, adapted for receiving and executing a plurality of instructions, each of the instructions has a target position and a target action such that a plurality of the target positions and a plurality of the target actions are defined, and the expandable mobile platform comprising:
a mobile platform, comprising:
a storage module, storing a map data and the instructions;
a positioning module, communicated with the storage module, utilized for determining a current position of the mobile platform by using the map data;
an instruction ordering module, communicated with the storage module and the positioning module, utilized for analyzing the target positions, defining the target position closest to the current position as a first target position which is ranked first in a position order table, defining the target position closest to the first target position as a second target position which is ranked second in the position order table, and aligning the instructions as an instruction serial based on ranking of the corresponding target positions in the order position table after all the target positions are ranked in the position order table; and
a control module, communicated with the instruction ordering module, receiving the instruction serial, generating a plurality of moving control signals corresponding to the plurality of target positions and a plurality of action control signals corresponding to the target actions accordingly, and controlling the mobile platform moving to the target positions according to the ranking in the position order table; and
an expandable working mechanism, disposed on the mobile platform, for receiving the action control signals corresponding to the target positions and the target actions to execute the target actions as the mobile platform is moved to the target positions.

2. The expandable mobile platform of claim 1, wherein the mobile platform further comprises a missing determination module, when missing determination module determines that the expandable mobile platform is executing a missing instruction among the instructions and is under a missing status, the missing determination module is utilized for generating a missing signal and transmitting the missing signal to the positioning module, the positioning module is utilized for determining a missing position of the expandable mobile platform, the instruction ordering module is utilized for eliminating the missing instruction, analyzing the target positions of the remaining instructions, defining the target position closest to the missing position as a first modified target position which is ranked first in a modified position order table, defining the remaining target positions closest to the first modified target position as a second modified target position which is ranked second in the modified position order table, and aligning the remaining instructions as a modified instruction serial based on ranking of the corresponding target positions in the order position table after all the remaining target positions are ranked in the modified position order table, and the control module is utilized for receiving the modified instruction serial to generate a plurality of modified moving control signals corresponding to the remaining target positions and a plurality of modified action control signals corresponding to the target actions of the remaining instructions, and controlling the mobile platform moving to the remaining target positions and controlling the expandable working mechanism executing the remaining target actions corresponding to the remaining target positions.

3. The expandable mobile platform of claim 2, wherein the missing determination module comprises:
a track determination unit, utilized for generating a track missing signal when determining that the mobile platform cannot move to one of the target positions and is under a track missing status of the missing status;
an action determination unit, utilized for generating an action missing signal when determining that the expandable working mechanism cannot execute one of the target actions and is under an action missing status of the missing status; and
a missing signal transmitting unit, communicated with the track determination unit and the action determination unit, for generating the missing signal when receiving at least one of the track missing signal and the action missing signal.

4. The expandable mobile platform of claim 1, wherein the expandable working mechanism comprises an action feedback unit, for generating an action completion feedback signal when the expandable working mechanism completes anyone of the target actions.

5. The expandable mobile platform of claim 1, wherein the storage module is a memory, a database, or a storage chip.

6. The expandable mobile platform of claim 1, wherein the positioning module comprises at least one of a GPS positioning unit, a Bluetooth positioning unit, and a Wifi positioning unit.

7. The expandable mobile platform of claim 1, wherein the instruction ordering module is a central processing unit (CPU).

8. The expandable mobile platform of claim 1, wherein the control module is a microcontroller unit (MCU).

9. The expandable mobile platform of claim 1, wherein the control module comprises:
a moving control unit, utilized for generating the moving control signals; and
an action control unit, utilized for generating the action control signals.
